(19) United States
(12) Patent Application Publication
(10) Pub. No.: US 2024/0422272 A1
(43) Pub. Date: Dec. 19, 2024

(54) IMAGE PROCESSING DEVICE

(71) Applicant: KYOCERA CORPORATION, Kyoto-shi, Kyoto (JP)

(72) Inventors: Hiroshi OKA, Kyoto-shi, Kyoto (JP); Kouichi MARUTA, Kirishima-shi, Kagoshima (JP); Shigeki TAKAYA, Yokohama-shi, Kanagawa (JP); Hirofumi SUZUKI, Koka-shi, Shiga (JP); Masatoshi GO, Kagoshima-shi, Kagoshima (JP)

(21) Appl. No.: 18/704,928

(22) PCT Filed: Oct. 28, 2022
(86) PCT No.: PCT/JP2022/040409

§ 371 Date: Apr. 26, 2024

(30) Foreign Application Priority Data
Oct. 29, 2021 (JP) 2021-177562
Mar. 30, 2022 (JP) 2022-055060

(51) Int. Cl. H04N 1/00

(52) U.S. Cl. CPC H04N 1/00517; H04N 1/00416; H04N 1/00474; H04N 1/00482; H04N 1/00514; H04N 2201/0094

(57) ABSTRACT

An image processing device includes an operation panel. The operation panel is configured to be capable of displaying a main screen and a sub-screen. The main screen includes a menu region in which multiple function buttons corresponding to types of image processing are arranged. The sub-screen is configured to be transitioned to from the main screen after one of the function buttons is selected. The sub-screen includes a reception region configured to accept an instruction for image processing related to the selected function button. In the sub-screen, a history display region is displayed alongside the reception region. The history display region is configured to display multiple history buttons including information on image processing completed previously specifically for image processing corresponding to the selected function button.

### RELATED APPLICATIONS

The present application is a National Phase of International Application Number PCT/JP 2022/040409, filed Oct. 28, 2022, and claims priority based on Japanese Patent Application No. 2021-177562, filed Oct. 29, 2021 and Japanese Patent Application No. 2022-055060, filed Mar. 30, 2022.

### TECHNICAL FIELD

The present invention relates to an image processing device. Image processing refers to various types of processing related to the handling of images, and includes, for example, printing images, scanning images, and transmitting and receiving image files.

### BACKGROUND OF INVENTION

A known image processing device can display image processing history (for example, see Patent Literature 1 listed below). For example, the image processing device of Patent Literature 1 displays multiple buttons (history buttons) relating to image processing history on an operation panel. The buttons are displayed in the order of the date and time when image processing was performed. Each history button displays the type of image processing (copying, scanning, etc.), the image processing conditions (number of copies, color/monochrome printing, single-sided/double-sided printing, etc.), and the date and time when the image processing was performed. When any one of the history buttons is selected via an operation panel equipped with a touch panel, the image processing conditions corresponding to that history button are set as the conditions for the image processing to be performed thereafter. In this way, conditions that have been set in the past can be easily utilized.

### CITATION LIST

### Patent Literature

Patent Literature 1: Japanese Unexamined Patent Application Publication No. 2018-125687

### SUMMARY

In an embodiment of the present disclosure, an image processing device includes an operation panel configured to be capable of realizing a prescribed display mode. The operation panel is configured to be capable of displaying a main screen and a sub-screen. The main screen includes a menu region in which multiple function buttons corresponding to types of image processing are arranged. The sub-screen is configured to be transitioned to from the main screen after one of the function buttons is selected. The sub-screen includes a reception region configured to accept an instruction for image processing related to the currently selected function button. In the sub-screen, a first history display region is displayed alongside the reception region. The first history display region is configured to display multiple history buttons including information on image processing completed previously specifically for image processing corresponding to the currently selected function button.

### BRIEF DESCRIPTION OF THE DRAWINGS

FIG. 1 is an external view of an image processing device according to an embodiment.

FIG. 2 is a block diagram illustrating an example of the configuration of the image processing device according to the embodiment.

FIG. 3 is a diagram illustrating an example of a main screen displayed on an operation panel of the image processing device in FIG. 1.

FIG. 4 is a diagram illustrating an example of a sub-screen (copy) transitioned to from the main screen in FIG. 3.

FIG. 5 is a diagram illustrating an example of a sub-screen (fax) transitioned to from the main screen in FIG. 3.

FIG. 6 is a diagram illustrating an example of a sub-screen (email) transitioned to from the main screen in FIG. 3.

FIG. 7 is a diagram illustrating an example of a main screen after user authentication.

FIG. 8 is a diagram illustrating an example of a sub-screen (copy) transitioned to from the main screen in FIG. 7.

FIG. 9 is a diagram illustrating an example of a main screen for when fixed display is set on the main screen.

FIG. 10 is a diagram illustrating an example of a sub-screen (copy) transitioned to from the main screen in FIG. 9.

FIG. 11 is a diagram illustrating an example of a sub-screen for when fixed display is set on a sub-screen (copy).

FIG. 12 is a diagram illustrating an example of a main screen transitioned to from the sub-screen in FIG. 11.

FIG. 13 is a diagram illustrating an example of a main screen accessed via the sub-screen (fax) in FIG. 5 from the main screen in FIG. 9 or FIG. 12.

FIG. 14 is a diagram illustrating another example of a main screen accessed via the sub-screen (fax) in FIG. 5 from the main screen in FIG. 9 or FIG. 12.

FIG. 15 is a diagram illustrating an example of a sub-screen (fax) displayed when inputting a communication destination.

FIG. 16 is a diagram illustrating an example of a sub-screen (mail) displayed when inputting a communication destination.

### DESCRIPTION OF EMBODIMENTS

### (Overview of Image Processing Device)

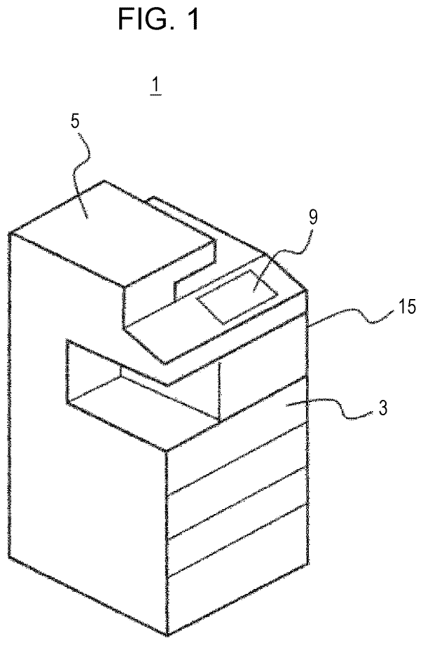

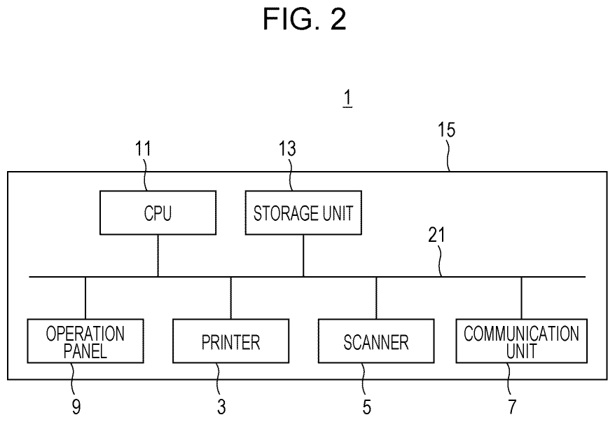

FIG. 1 is an external view of an image processing device 1 according to an embodiment. FIG. 2 is a block diagram illustrating the configuration of the image processing device 1.

The image processing device 1 is configured as a multifunction machine and includes, for example, the following sections. A printer 3 that performs printing. A scanner 5 that scans images. A communication unit 7 that communicates with the outside. An operation panel 9 that accepts operations from a user. A CPU 11 (central processing unit) that performs various operations. A storage unit 13 that stores various information. A housing 15 that holds these sections.

The operation panel 9 is provided in an upper part of the housing 15 and includes a touch panel. The operation panel 9 may include operation targets other than the touch panel such as physical buttons. However in the description of the embodiments, the description may be made under the assumption that the operation panel 9 includes only a touch panel.

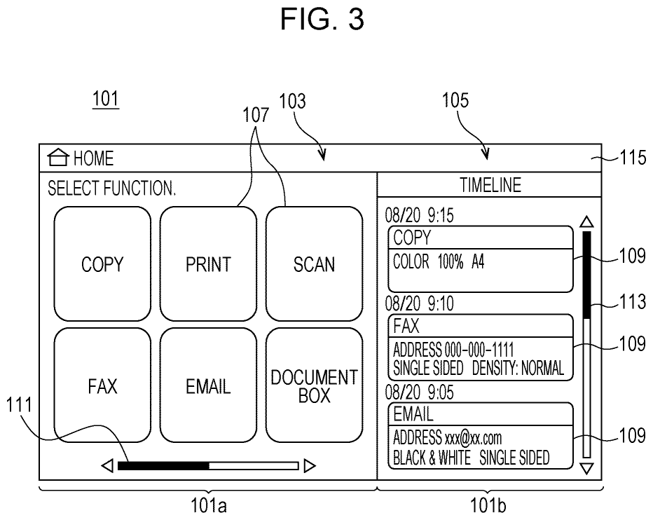

FIG. 3 is a diagram illustrating an example of a main screen 101 displayed on the operation panel 9. A home screen is illustrated here as an example of the main screen 101.

The main screen 101 is, for example, a screen that is displayed when a user starts using the image processing device 1 or when the device is in standby mode. From another perspective, the main screen 101 is a screen that is launched when power to the image processing device 1 is turned on, when the image processing device 1 is restored from sleep mode, and/or when the user is successfully authenticated by the image processing device 1.

The main screen 101, for example, displays a menu region 101a and a history display region (timeline display region) 101b side by side. The menu region 101a displays a partial region out of a main region 103. The range that the partial region occupies out of the main region 103 may be indicated by a scroll bar 111. In addition, the history display region 101b displays a partial region out of a history region (timeline region) 105. The range that the partial region occupies out of the history region 105 may be indicated by a scroll bar 113.

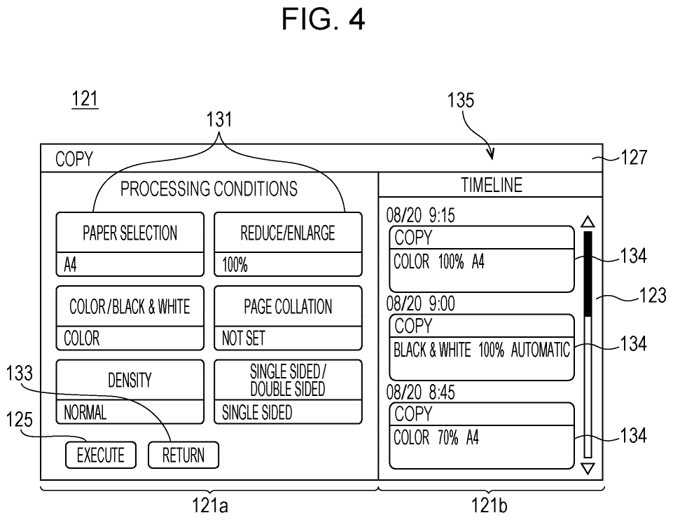

Multiple function buttons 107 corresponding to different types of image processing are arranged in the menu region 101a (main region 103). The multiple function buttons 107 are for selecting any one function from among different functions (image processing functions from another perspective). The function buttons 107 display information about their corresponding functions. “Copy”, “print”, “scan”, “fax” (facsimile), “email”, and “document box” are illustrated as examples of functions in FIG. 3. When a prescribed operation (for example, a single touch (for example, a tap)) is performed on any of the function buttons 107, for example, the screen displayed on the operation panel 9 switches to a screen (sub-screen 121 (for example, FIG. 4)) for performing operations related to the function corresponding to that function button 107. In other words, after one function button 107 has been selected on the main screen 101, the main screen 101 transitions to the corresponding sub-screen 121. Operations relating to the function are, for example, an operation for executing image processing and an operation for setting conditions for the image processing (for example, the paper size when making a copy).

The history region 105 includes multiple history buttons 109. Each history button 109 contains (displays) information regarding image processing (function) performed in the past. In FIG. 3, the date and time when the image processing was performed, the type of image processing (“copy”, “fax”, or “email” for example in FIG. 3), the image processing conditions (“color” or “black & white” for example in FIG. 3) are illustrated as examples of information on image processing displayed on the history buttons 109. In addition, communication destinations (hereinafter referred to as “addresses”) may be displayed on the history buttons 109 When a prescribed operation (for example, a single touch (for example, a tap)) is performed on any one of the history buttons 109, the screen displayed on the operation panel 9 switches to a history use screen (not illustrated), for example. The history use screen is a screen allowing history information corresponding to that history button 109 to be utilized.

FIG. 4 is a diagram illustrating an example of the sub-screen 121 displayed on the operation panel 9. More precisely, an example of the sub-screen 121 for when the “copy” function button 107 is selected from among the six function buttons 107 illustrated in FIG. 3 is illustrated. The sub-screen 121 is a screen related to image processing corresponding to the selected function button 107. The sub-screen 121 displays a reception region 121a and a history display region 121b side by side. The reception region 121a accepts instructions for image processing related to the selected function button 107. The history display region 121b contains multiple history buttons 134 that contain history information on image processing completed in the past specifically for the image processing corresponding to the currently selected function button 107. In addition, the history display region 121b displays a partial region out of a history region (timeline region) 135. The range that the partial region occupies out of the history region 135 may be indicated by a scroll bar 123.

The image processing device 1 may have or not have a function of identifying users (and a function of authenticating users) (Unless otherwise noted and unless any contradictions arise, “user” is assumed to include user groups. The same applies hereafter). In order to simplify the description, for convenience, an embodiment with or without such an identification function and such an authentication function will be referred to as a First Embodiment, and an embodiment in which the presence of such an authentication function is assumed will be referred to as a Second Embodiment, and the embodiments will be described in this order. However, for convenience, information, configurations, and operations with the assumption that the image processing device 1 has a function of identifying (and authenticating) users may be referred to even in the description of the First Embodiment.

### First Embodiment

Hereafter, the image processing device 1 according to the First Embodiment will be briefly described in the following order.
1.1. Terminology, etc.
1.2. Configuration of Image Processing Device 1 (FIGS. 1 and 2)
1.3. Operation of Image Processing Device 1 Relating to Main Screen 101 (FIG. 3)
1.4. Operation of Image Processing Device 1 Relating to Sub-Screen 121 (FIGS. 4 to 6)

### 1.1. Terminology, Etc.

An “image” may contain only text. “Image data” may be in various formats, for example, may be in a vector format or a raster format. In the description of the embodiments, “image” and “image data” are not always strictly distinguished from each other for the sake of convenience.

“Image data” may be converted to other formats as appropriate while image processing is being performed. For example, image data may be in different formats when stored in the image processing device 1 and when image processing (for example, printing, scanning, faxing, sending/receiving of image files, and so on) is performed. However, in the description of the embodiments, for convenience, description of such format conversions may be omitted and the image data before and after conversion may be described as being identical. The image data may be altered such that the quality of the image is changed or a portion of the image is cropped, for example, when image processing is performed. In such cases, the description of the embodiments may sometimes not distinguish between the image data before and after being altered for the sake of convenience.

The information displayed in the various sections of the various screens of the operation panel 9 (for example, the history buttons 109 and 134) may be displayed in the form of text and/or symbol images. In the description of the embodiments, for example, when information is displayed on the operation panel 9 or when a section (button, etc.) displayed on the operation panel 9 contains information, the information may be displayed in the form of text and/or symbol images so long as there are no particular inconsistencies and so on. For example, in addition to the history buttons 109 and 134, examples of sections where information is displayed include the function buttons 107, an execute button 125, settings buttons 131 (described below), a return button 133 (described below), the regions around these buttons, and title bars 115 and 127 (described below).

“Text” may refer to, for example, information displayed as a string of characters and/or information displayed based on text data. Therefore, for example, text may be a string of characters displayed based on image data, or may be a symbol or only one character displayed based on text data. A “symbol image” may refer to, for example, information displayed as a symbol or graphic and/or information displayed based on image data. Therefore, for example, a symbol image may be a symbol displayed based on text data, or may be one or more characters displayed based on image data. As understood from the above description, text and symbol images may be partially overlapping classifications.

The “buttons” displayed on the operation panel 9 do not need to resemble physical buttons. For example, a button may be indicated only by text and/or a symbol image and does not need to have a border surrounding the text and/or symbol image. From another perspective, for example, the boundary between the region where a user's operation is detected and the surrounding region does not need to be represented by an enclosing line or a difference in color.

In the description of the embodiments, for convenience, terms indicating specific modes such as “tap,” “double tap,” and “long tap” may be used to describe operations performed on the operation panel 9. However, these terms may be generically conceptualized as “prescribed operations”.

### 1.2. Configuration of Image Processing Device

The image processing device 1 illustrated in FIGS. 1 and 2 includes the operation panel 9 and is configured to be capable of performing one or more types of image processing. The specific configurations used may be any of various configurations, and, for example, known configurations may be used. In this embodiment, as has already been mentioned, the printer 3, the scanner 5, and the communication unit 7 are provided as configurations for performing image processing. Embodiments different from this embodiment include, for example, an embodiment including only one out of the printer 3 and scanner 5, and a mode not including the communication unit 7. The configurations of the parts (3, 5, 7, 9, 11, and 13) of the image processing device 1 may also be any of various configurations, for example, may be known configurations.

The image processing device 1 includes, for example, the housing 15. The housing 15 houses the various previously mentioned components (3, 5, 7, 9, 11, and 13). The image processing device 1 (housing 15 from another perspective) may be of any size and any shape. For example, the image processing device 1 may be of such a size (mass) as to be able to be carried by one person such as a home-use multifunction machine or printer, or may be of such as size (mass) as to not able to be carried by one person such as a commercial-use multifunction machine or printer.

The method of operation (or social role from another perspective) of the image processing device 1 may be any method of operation. For example, the image processing device 1 may be placed in a home for domestic or personal use, may be placed in a company for use by specific users and multiple users, or may be placed in a store such as a convenience store for use by an unspecified number of users. When the image processing device 1 is intended for use by an unspecified number of users, the image processing device 1 may authenticate a user and allow access only to image data related to that user.

The printer 3 may have any configuration. For example, the printer 3 may be configured to perform printing on paper (sheet paper from another perspective) disposed in a tray, which is not illustrated, and eject the paper after printing. The printer 3 may include only one tray or multiple trays. Multiple trays, for example, contribute to accommodating paper of different sizes. From another perspective, the printer 3 may have or not have a function of selecting the paper size. In the description of this embodiment, the former is taken as an example. The printer 3 may be configured to be capable of printing in color (and monochrome and grayscale), may be configured to be capable of printing only in grayscale (and monochrome), or may be configured to be capable of printing only in monochrome. In the description of this embodiment, a configuration capable of printing in color is taken as an example.

For example, the printer 3 may be an inkjet printer that prints by ejecting ink, a thermal printer that prints by heating thermal paper or an ink ribbon, or an electrophotographic printer (for example, a laser printer) that transfers toner attached to a photoreceptive medium irradiated with light. The inkjet printer may be a piezoelectric printer in which pressure is applied to the ink by a piezoelectric body, or a thermal printer in which pressure is applied to ink by bubbles created in ink to which heat is applied. For example, the printer 3 may be a line printer in which the head has a length that spans the width of the paper (in a direction that intersects a paper transport direction), or may be a serial printer in which the head moves in the width direction of the paper.

Although not specifically illustrated, for example, the scanner 5 performs scanning by capturing an image of a document placed on a document glass by using multiple image-capturing elements that move along the document glass under the document glass.

The communication unit 7 realizes communication between the image processing device 1 and other devices. Examples of other devices include personal computers (PCs), mobile terminals (for example, smartphones), other image processing devices, and servers. Examples of servers include file servers, mail servers, and web servers. Communication may be performed directly with other devices or indirectly over a network. Examples of networks include telephone networks, the Internet, private networks, and local area networks (LANs). The communication may be wired communication, wireless communication, short-range communication, or long-range communication.

The image processing device 1 may be configured to be capable of performing any one or more of the various types of communication described above. In the description of this embodiment, a mode in which the image processing device 1 can perform various types of communication as described above will be taken as an example. Although not specifically illustrated, the communication unit 7 includes various components for realizing the various types of communication described above. The communication unit 7 may be considered to include only a hardware configuration (for example, a connector, an antenna, an amplifier, a filter, and a radio-frequency (RF) circuit), or may be considered to include a software configuration (a functional unit created by a CPU executing a program) in addition to the hardware configuration.

The operation panel 9 includes a touch panel, as already mentioned. Although not specifically illustrated, the touch panel includes a display device and a position input device that overlaps a screen of the display device. The display device and the position input device may have any configurations.

For example, the display device may be constituted by a liquid crystal display or an electroluminescence (EL) display. These displays contain a relatively large number of regularly arranged pixels and can display images containing any shapes based on image data. The display device may be capable of displaying color images, may be capable of displaying only grayscale images (and monochrome images), or may be capable of displaying only monochrome images (binary images).

In addition, for example, the position input device may be an electrostatic input device or a pressure sensitive position input device. An electrostatic position input device detect changes in the electrostatic capacitance of the screen and/or the vicinity thereof due to contact or proximity of a finger or pen. A pressure-sensitive position input device detects pressure exerted on the screen. In addition, the position input device may utilize surface acoustic waves, infrared light, or electromagnetic induction. The position input device may require or not require a dedicated pen.

In the description of this embodiment, for convenience, operations performed on the operation panel 9 (operations performed on software buttons and so on) may be described under the assumption that contact is made. However, as understood from the above description, an operation may be detected without contact being made.

The CPU 11 creates a functional unit that executes various types of processing by executing programs stored in the storage unit 13. An example of such a functional unit is a controller. The controller controls operation of the printer 3, the scanner 5, the communication unit 7, and the operation panel 9. In addition to the part created by the CPU 11, the controller may also include logic circuits configured to perform only certain operations.

Although not specifically illustrated, for example, the storage unit 13 includes various types of memory such as a ROM (read only memory), a RAM (random access memory), and an auxiliary storage device. The combination of the CPU 11 and the storage unit 13 may be regarded as a computer. The program that the above-mentioned CPU 11 uses to build the controller is stored, for example, in the ROM and/or auxiliary storage device of the storage unit 13.

The various components (3, 5, 7, 9, 11, and 13) described above are connected to each other by a bus 21, for example. In FIG. 2, all the components are schematically connected to a single bus 21. In an actual product, multiple buses may be connected in any appropriate manner. For example, address buses, data buses, and control buses may be provided. Crossbar switches and/or link buses may also be used. An interface, which is not illustrated, may be interposed between the bus 21 and various components (3, 5, 7, and 9, and so on).

FIG. 2 is merely a schematic diagram. Therefore, for example, multiple CPUs and storage units (or controllers from another perspective) may be provided in a distributed manner. For example, a CPU (from another perspective, a controller that controls a corresponding component) in each component (3, 5, 7 and/or 9) and a higher-level CPU (a higher-level controller that controls the controllers in the individual components) may be provided. In such a case, the controller referred to in the description of the embodiments may be viewed as a higher-level controller or the controller may be viewed as a combination of the controllers of the individual components and a higher-level controller. As is understood from the above description, the controller and the components (3, 5, 7, and/or 9) do not necessarily need to be clearly distinguishable from each other.

### 1.3. Operation of Image Processing Device Relating to Main Screen

The main screen 101 illustrated in FIG. 3 is displayed so as to span the entire screen of the operation panel 9, for example. The main screen 101 may include (and display), for example, the main region 103, the history region 105, and the scroll bars 111 and 113, as previously described.

The main screen 101 displays the menu region 101a and the history display region 101b side by side. The history display region 101b includes the multiple history buttons 109 containing information on image processing completed in the past for multiple different types of image processing corresponding to the function buttons 107 of the menu region 101a. In addition, the main screen 101 may include other appropriate sections such as the title bar 115 located at the top of the screen.

Hereafter, brief description will be given in the following order.
1.3.1. Operation of Image Processing Device 1 Relating to Main Region 103
1.3.2. Operation of Image Processing Device 1 Relating to History Region 105 (Mainly Operations up to Transition to Sub-Screen 121)

### 1.3.1. Operation of Image Processing Device Relating to Main Region

The display mode of the main region 103 and the processing executed when any of the function buttons 107 is selected may be any of various display modes and processing, and, for example, may be the same as or similar to known display modes and processing.

In the example in FIG. 3, a partial region out of the main region 103 is displayed in the menu region 101a, as previously described. Unlike in the illustrated example, the entire main region 103 may be displayed in the menu region 101a. From another perspective, the multiple function buttons 107 may be provided in a number greater than the maximum number that can be simultaneously displayed (illustrated example) or less than the maximum number. In the mode in which a partial region out of the main region 103 is displayed in the menu region 101a, the direction in which the main region 103 is scrolled (left or right in the illustrated example) may be any direction.

The number of function buttons 107 and the types of functions corresponding to the function buttons 107 may be set as desired. The number of function buttons 107 may be increased or decreased by the user. The function buttons 107 illustrated in FIG. 3 are described below.

Note that, hereafter, the function buttons 107 may be referred to using the text displayed inside the function buttons 107. This also applies to other buttons.

“Copy” is for setting settings relating to and/or executing a function of printing images scanned by the scanner 5 using the printer 3 (copy function).

“Print” is, for example, for setting settings relating to and/or executing a function of printing images based on data stored on a recording medium (not illustrated) connected to the image processing device 1 using the printer 3. The storage medium is, for example, a USB (universal serial bus) memory. Note that in the description of the embodiments, unless otherwise noted or unless there are contradictions, the term “print” is not limited to referring to printing performed using the “print” function button 107 (For example, printing performed in response to reception of a print job from the outside may be included).

“Scan” is for setting settings related to and/or executing a function of saving images scanned by the scanner 5 as data. The storage destination is, for example, an auxiliary storage device (nonvolatile memory from another perspective) included in the storage unit 13, a storage medium connected to the image processing device 1, or another device that communicates with the image processing device 1 via the communication unit 7. Note that, in the description of embodiments, unless noted otherwise or unless there are any contradictions, the term “scan” is not limited to referring to scanning performed using the “scan” function button 107 (for example, scanning performed during copying may be included).

“Fax” is for setting settings relating to and/or executing faxing. When transmitting a fax, for example, an image of a document to be transmitted is scanned by the scanner 5, and the data of the scanned image is transmitted by the communication unit 7. When receiving a fax, for example, image data is received by the communication unit 7 and printing based on the received image data is performed by the printer 3.

“Email” is for setting settings related to electronic mail and/or executing electronic mail, and is used to send and confirm receipt of emails with attached image files. In this function, for example, part or all of the contents of an email received by the communication unit 7 may be printed by the printer 3. In addition or alternatively, data of an image read by the scanner 5 may be attached to an email in the form of an image file and transmitted by the communication unit 7. Furthermore, image data stored in a document box may be attached in the form of an image file and included in an email transmitted by communication unit 7.

“Document box” is, for example, for browsing information on any number of pieces of image data stored in the auxiliary storage device (from another perspective, nonvolatile memory) included in the storage unit 13, and for setting settings relating to and/or executing a function of performing image processing on selected image data. Image processing is, for example, printing, sending by fax, or sending by email.

As already mentioned, for example, when any of the function buttons 107 is tapped, the screen displayed on the operation panel 9 switches to a sub-screen 121 (for example, FIG. 4) for performing operations related to the function corresponding to that function button 107. FIG. 4 illustrates a sub-screen that is transitioned to when the function button 107 corresponding to “copy” is selected.

### 1.3.2. Operation of Image Processing Device Relating to History Region

The display mode of the history region 105 may be any of various display modes, and for example, may be the same as or similar to known display modes.

The position, shape, and area of the history display region 101b may be freely chosen. In the example in FIG. 3, the history display region 101b is positioned on one side (the right-hand side in the illustrated example) in the horizontal direction of the rectangular main screen 101 (the entire screen of the operation panel 9 from another perspective), which has the horizontal direction as its longitudinal direction. The history display region 101b has a rectangular shape with the vertical direction being the longitudinal direction of its rectangular shape. The width of the history display region 101b is less than ½ or ⅓ of the width of the main screen 101. The majority (for example, 80% or more) of the main screen 101, excluding the history display region 101b, constitutes the menu region 101a.

In the example in FIG. 3, part of the history region 105 is displayed in the history display region 101b, as previously described. Unlike in the illustrated example, the entire history region 105 may be displayed in the history display region 101b. From another perspective, the multiple history buttons 109 may be provided in a number greater than the maximum number that can be simultaneously displayed (illustrated example) or provided in a number less than or equal to the maximum number. In a mode in which a partial region of the history region 105 is displayed in the history display region 101b, the direction in which scrolling is performed (vertical direction in the illustrated example) may be any direction.

The multiple history buttons 109 are, for example, arranged in a single row in a prescribed direction in the order of the date and time image processing operations corresponding to the history buttons 109 were executed. The direction in which the multiple history buttons 109 are arranged may be any direction. In the example in FIG. 3, the arrangement directions are the vertical direction of the main screen 101, the longitudinal direction of the history display region 101b, and the direction in which the history region 105 is scrolled. The multiple history buttons 109 may be arranged from one side to the other side in the arrangement direction (from top to bottom in the illustrated example), in order from newest to oldest, or may be switchable between from newest to oldest and from oldest to newest by performing prescribed an operation on the operation panel 9. In the description of this embodiment, for the sake of convenience, the history buttons 109 are assumed to be arranged in order from newest to oldest.

When image processing is executed via an operation performed on a function button 107 or when image processing is executed via an operation performed on a history button 109, a new history button 109 is added for that image processing. If the image processing that led to the addition of a history button 109 is the same as new image processing that was performed via an operation performed on that history button 109, the history button 109 may be added anew, or the date and time of the executed image processing corresponding to the operated history button 109 may be updated (from another perspective, the display position of the history button 109 may be changed). The image processing operations referred to here may be identical, for example, except for the date and time of execution. However, other differences may exist besides the date and time of execution. Unlike in the description of this embodiment, a history button 109 does not need to be added for image processing executed via an operation performed on a history button 109.

The types of image processing for which the history buttons 109 are generated may be any type of image processing. For example, even if the image processing device 1 has the six functions illustrated on the main screen 101, the history buttons 109 do not need to be generated for all of the functions. For example, the history buttons 109 may be generated only for image processing in which printing is performed by the image processing device 1, such as “copy” and “print” (and printing in “document box”). In addition, the history buttons 109 may be generated only for image processing in which scanning is performed by the image processing device 1 such as “copy”, “scan”, “fax”, and “email”. The history buttons 109 may be generated only for image processing in which no communication takes place, for example, “copy”, “print” and “scan” (and printing in “document box”).

For image processing that is performed by transmitting a signal including a print job, etc., from another device (for example, a PC) to the communication unit 7, a history button 109 may be added or not added. If a history button 109 is added, for example, the user who sent a print job from a PC to the image processing device 1 can reprint the job via the history button 109 when he or she observes a print failure in front of the image processing device 1. In the description of this embodiment, basically, description of the addition of history buttons 109 accompanying this type of image processing whose execution is instructed via communication with the outside is omitted. In a mode where a history button 109 is added, in the description of this embodiment, so long as there are no contradictions or the like, an instruction for executing image processing using a signal from the outside may be added to the place where an instruction for executing the image processing using the operation panel 9 is described.

The number of history buttons 109 provided in the history region 105 is limited to being no more than a prescribed upper limit. In other words, the number of history buttons 109 (including those displayed by scrolling) that can be displayed in the history display region 101b is limited to being no more than the prescribed upper limit. Thus, for example, when the history buttons 109 are added as described above, if an additional new history button 109 is to be added after the number of history buttons 109 has reached the upper limit, the oldest history button 109 will be deleted. In other words, the oldest history button 109 will not be displayable.

The specific value of the upper limit may be set to any value and is 5, 10, or 20, for example. The upper limit may be set by the manufacturer of the image processing device 1 and may be unchangeable by the administrator or user of the image processing device 1, or may be set by the administrator of the image processing device 1. In a mode where the display mode of the history region 105 can be made different for each user, the upper limit may be set by the user.

If the number of history buttons 109 has not reached the upper limit, the display mode may be any display mode. For example, only a number of history buttons 109 below the upper limit may be displayed, or dummy history buttons (for example, history buttons that do not display information thereinside) may be displayed together with the history buttons 109 so that in total the upper limit number of history buttons is displayed. In the former mode, the length of the history region 105 may vary or not vary in accordance with the number of history buttons 109.

The image processing device 1 may be capable of operating differently from the above description with respect to the addition, deletion, and arrangement of the history buttons 109. For example, by performing, on any history button 109, an operation (for example, a long tap or a double tap) that is different from the operation performed when the history information corresponding to that history button 109 is to be used (switching to a history use screen), deletion of that history button 109 may be prohibited, that history button 109 may be caused to be always disposed above the most recent history button 109, or that history button 109 may be deleted. In the description of this embodiment, for the sake of conciseness of explanation and ease of understanding, the descriptions or wordings may assume that such operations are not performed.

The multiple history buttons 109 may, for example, have the same shape and size as each other (illustrated example), or may have different shapes and/or sizes from each other. An example of the latter is a mode in which the multiple history buttons 109 have different shapes and/or sizes from each other depending on the type of image processing (differences such as copying or scanning).

Each history button 109 contains (displays) information on the corresponding image processing. Examples of this information include, for example, the date and time the image processing was performed, the type of image processing, the conditions of the image processing, and the user name of the user who performed the image processing, as described previously. Other examples include communication destinations (sender and/or receiver) in the fax function and/or email function.

Information on image processing may include information on the image data handled in the image processing. Information on the image data includes, for example, the size of the image data, the type of image as determined by the image processing device 1 (for example, document or not document), and the name given to the image data by the image processing device 1. For the sake of convenience, in the description of this embodiment, description of information on image data as information on image processing is omitted.

Each history button 109 may display at least one or more pieces of information from among the various pieces of information on image processing (for example, date and time, type, processing conditions, user name, and communication destination) described above. Image processing conditions include a variety of specific conditions, as exemplified in the description of FIG. 3 and the description of FIGS. 4 to 6 below. In a mode in which conditions of the image processing are displayed within the history buttons 109, the specific conditions that are displayed may be selected as appropriate. In FIG. 3, the color condition (“color” or “black & white” for example), the magnification setting (“100%” for example), and the paper condition (“A4” for example) are illustrated.

The history buttons 109 may contain the same type of image processing information (in other words, the items displayed on the history buttons 109), or may contain different types of image processing information from each other. For example, the types of information displayed on the history buttons 109 may vary depending on the type of image processing. More specifically, for example, a history button 109 in which the type of image processing is copying does not include an entry for displaying a communication destination, whereas a history button 109 in which the type of image processing is fax or email may include an entry for displaying the communication destination.

History information corresponding to any of the history buttons 109 can be utilized by performing a prescribed operation on the history button 109. For example, new image processing may be performed using the image processing conditions contained in the history information. In addition, image processing of the type included in the history information may be performed. Any of various specific modes may be used to realize the use of such history information. For example, the screen may transition to a history use screen, as described previously. The history use screen may be the same as or similar to the sub-screen 121, for example. In this case, the processing conditions included in the history information may be set as the processing conditions. Then, either with the processing conditions remaining as they are or after the processing conditions have been adjusted using the settings buttons (see settings buttons 131), new image processing may be performed by operating the execute button (see execute button 125).

### 1.4. Operation of Image Processing Device Relating to Sub-Screens

The sub-screen 121 illustrated in FIG. 4 displays the reception region 121a and the history display region 121b side by side. The reception region 121a accepts instructions for image processing related to the currently selected function button 107. The history display region 121b contains multiple history buttons 134 that contain history information on image processing completed in the past, specifically image processing corresponding to the currently selected function button 107.

The sub-screen 121 includes (and displays) the execute button 125, the settings buttons 131, and the history buttons 134. The history buttons 134 contain information on image processing completed in the past, specifically image processing corresponding to the function button 107 currently selected on the main screen 101 (FIG. 3). The example illustrated in FIG. 4 illustrates that, when the “copy” function button 107 is selected on the main screen 101 (FIG. 3), the history buttons 134 contain information on image processing completed in the past specifically for “copy”. The history buttons 134 may be displayed using scrolling. In a mode in which a partial region of the history region 135 is displayed in the history display region 121b, the direction in which scrolling is performed (vertical direction in the illustrated example) may be any direction. The settings buttons 131 are buttons for checking and setting items such as conditions for image processing. The settings buttons 131 may be used to check and set setting items other than processing conditions (for example, the communication destination). However, hereafter, the processing conditions may be taken as examples unless otherwise noted. In addition, the sub-screen 121 may include (and display) the following, for example. The title bar 127 of the sub-screen 121. The return button 133 for returning to the main screen 101.

Any layout may be adopted for the various sections described above, and FIG. 4 merely illustrates one example. In the example in FIG. 4, generally speaking, there is a region in which the multiple settings buttons 131 are arranged (reception region 121a) and a region in which the multiple history buttons 134 are arranged (history display region 121b). The history display region 121b is displayed alongside the reception region 121a on the sub-screen 121. In the example in FIG. 4, the reception region 121a and the history display region 121b are arranged in this order from left to right. The position, shape and/or area of the history display region 121b may be the same as (illustrated example) or different from the position, shape and/or area of the history display region 101b on the main screen 101. In any case, the previous description of the position, shape and area of the history display region 101b (and menu region 101a) may be applied to the history display region 121b (reception region 121a).

The multiple settings buttons 131 are provided so as to correspond to multiple setting items (for example, processing conditions), for example. When any of the settings buttons 131 is tapped, for example, a screen or window allowing setting of the corresponding item is displayed on the operation panel 9. This allows, for example, the corresponding item to be changed from the current setting.

Each settings button 131 displays information indicating the type of setting item corresponding to the button. Each settings button 131 may also display information indicating the setting status of the item corresponding to the button. In the illustrated example, the type of the setting item is displayed in the upper part of each settings button 131, and the current setting status of that item is displayed in the lower part of the settings button 131.

As is understood from the previous description, the number and types of the settings buttons 131 may be freely chosen. In the example in FIG. 4, “paper selection”, “color/black & white”, “density”, “reduce/enlarge”, “page collation”, and “single sided/double sided” are illustrated as the settings buttons 131 when the history button 109 corresponding to copying has been selected. In the lower parts of the settings buttons 131, “A4”, “color”, “normal”, “100%”, “not set”, and “single sided” are illustrated as examples of the current settings for these items. Since these are typical settings, description thereof is omitted.

The history buttons 134 on the sub-screen 121 contain information on image processing completed in the past, specifically image processing corresponding to the function button 107 selected on the main screen 101. Similarly to the history buttons 109 on the main screen 101, the information on image processing displayed on the history buttons 134 may include text or symbol images relating to at least one selected from the group consisting of the type of image processing, processing conditions, date and time of processing, user name, and communication destination. Types of image processing include at least copying, scanning, and faxing. In the example in FIG. 4, “copy” is illustrated as the type of image processing for the history button 134 specifically for the currently selected “copy” function. The processing conditions includes at least one from among image quality and page layout. In FIG. 4, the color condition (“color” or “black & white” for example) related to image quality, the magnification setting (“100%” or “70%” for example) related to page layout, and the paper condition (“A4” or “automatic” for example) related to paper size are illustrated as image processing conditions.

The specific display mode of the history buttons 134 (position, shape, area, display content, creation, deletion, etc.) may be the same as or different from that of the history buttons 109 on the main screen 101. For example, if the “copy” function button 107 is selected and the corresponding sub-screen 121 is displayed, since the history buttons 134 clearly contain information specific to “copy”, the history buttons 134 do not need to contain the information “copy” unlike the history buttons 109. In any case, the preceding description of the specific display mode for the history buttons 109 may be applied to the history buttons 134, except for points specific to the image processing corresponding to the selected function button 107, as long as no inconsistencies arise.

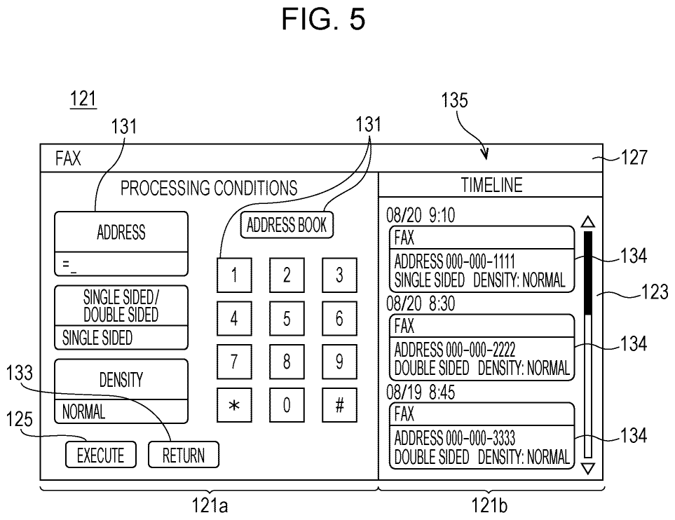

FIG. 5 illustrates an example of the sub-screen 121 transitioned to from the main screen 101 after the “fax” function button 107 is selected on the main screen 101 in FIG. 3. The example illustrated in FIG. 5 illustrates that the history buttons 134 specific to “fax” are displayed when the “fax” function button 107 is selected on the main screen 101 (FIG. 3). The settings buttons 131 on the sub-screen 121 also include an address book button or a numeric keypad for entering a fax address.

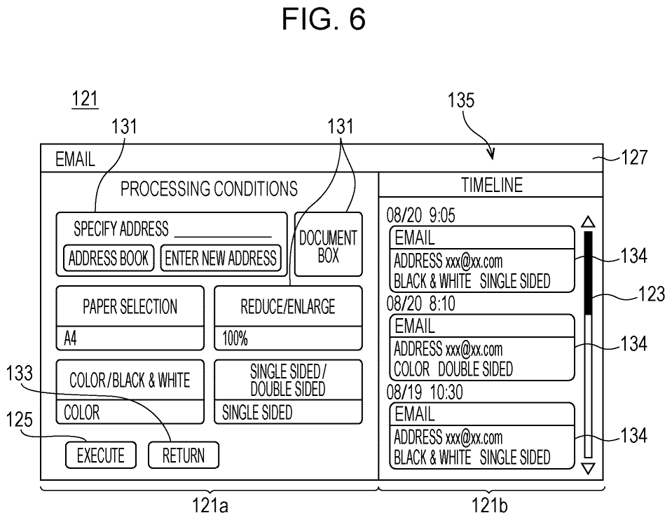

FIG. 6 illustrates an example of the sub-screen 121 transitioned to from the main screen 101 after the “email” function button 107 is selected on the main screen 101 in FIG. 3. The example illustrated in FIG. 6 illustrates that the history buttons 134 specific to “email” are displayed when the “email” function button 107 is selected on the main screen 101 (FIG. 3). When transmitting image data using this “email” function, the data of an image scanned by the scanner 5 may be included in an email transmitted by the communication unit 7, or image data stored in the document box may be included in an email transmitted by the communication unit 7. The settings buttons 131 on sub-screen 121 also include a “document box” button for accessing the document box.

On any of the sub-screens 121, history information corresponding to the history buttons 134 can be utilized by performing prescribed operations on the history buttons 134. For example, new image processing may be performed using the image processing conditions contained in the history information. Any of various specific modes may be used to realize the use of such history information. For example, when a prescribed operation is performed on any of the history buttons 134 on the sub-screen 121, the currently set processing conditions may be changed to the processing conditions contained in the history information corresponding to the history button 134 on which the operation was performed. Then, either with the processing conditions remaining as they are or after the processing conditions have been adjusted using the settings buttons 131, new image processing may be performed by operating the execute button 125.

In the image processing device according to the First Embodiment, the sub-screen 121 displays the history buttons 134 (for example, history buttons for “copying”) specifically for the image processing corresponding to the currently selected function button 107 (for example, “copy”). Consequently, the complexity caused by multiple history buttons for different types of image processing being mixed together thereby increasing the difficulty of finding the type of history button needed is eliminated, and user convenience can be improved.

### Second Embodiment

In the description of the Second Embodiment, basically, only the differences from the First Embodiment will be described. Similarly, in the third and Fourth Embodiments described below, basically, only the differences from the previously described embodiments will be described. Matters not specifically mentioned may be assumed to be the same as those in the previously described embodiments, or may be inferred from the previously described embodiments.

The Second Embodiment differs from the First Embodiment in that a function for authenticating users is assumed. However, the Second Embodiment may be viewed as a sub-concept of the First Embodiment. Therefore, the symbols and so on referring to the components are the same in both embodiments.

An image processing device of the Second Embodiment further includes an authentication management unit that grants authorization for image processing to each user based on the results of user authentication.

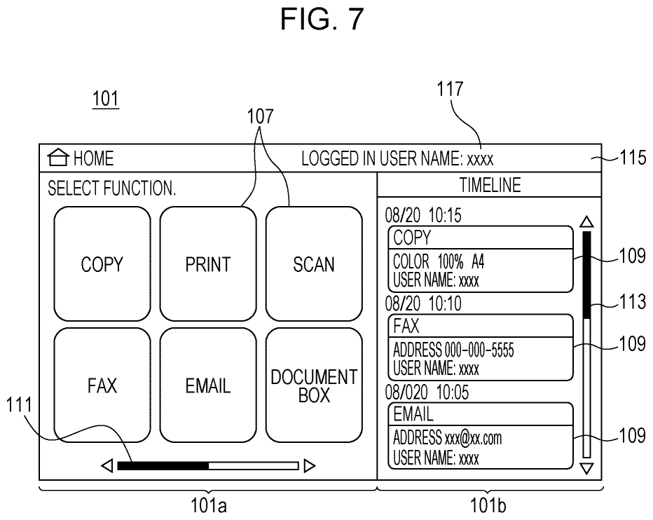

The main screen 101 in the Second Embodiment is illustrated in FIG. 7. FIG. 7 is the main screen after user authentication, with a user name 117 displayed in the title bar 115. In the example in FIG. 7, the user name is written as “xxxx” for illustrative purposes. The user name is also displayed on the history buttons 109 in the Second Embodiment.

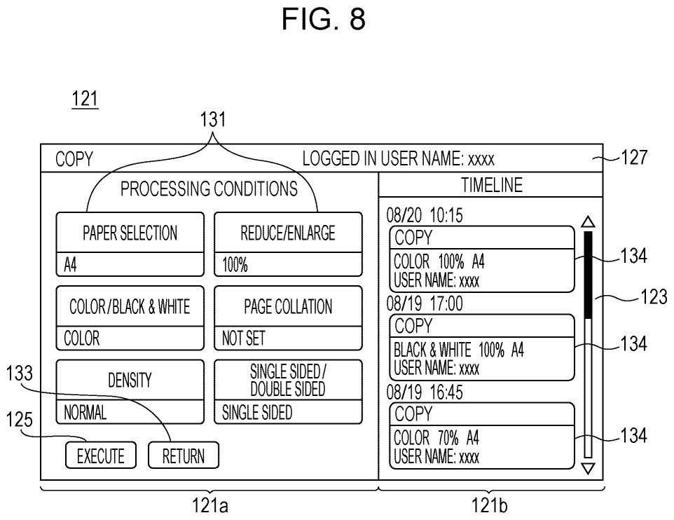

The sub-screen 121 in the Second Embodiment is illustrated in FIG. 8. FIG. 8 is a diagram illustrating an example of a sub-screen (copy) transitioned to from the main screen in FIG. 7.

Identification information identifying a user may be, for example, the “user name” illustrated as information on image processing in the description of the First Embodiment. In the First Embodiment, the user name was used as information displayed to allow the user to identify or confirm the history buttons 109. In this embodiment, furthermore, image data that is allowed to be accessed or the history buttons 109 that are displayed may differ depending on the user who is logged into the image processing device 1.

The “user name” may be, for example, a string of characters set by the user or the administrator of the image processing device 1. The image processing device 1 may allocate another type of identification information to the user name and store the two types of information together, and this would allow database searches and so on to be performed using another type of identification information. In other words, identification information used externally (user name) may be different from identification information used internally. However, since the two types of identification information may be viewed as being conceptually identical, the user name will be described as being used internally in this embodiment.

Authentication is an operation for checking whether or not a user who is attempting to use the image processing device 1 (attempting to log into the image processing device 1) is a pre-registered user (from another perspective, a user who is associated with a user name). The authentication method may be any one of various methods, for example, a known method.

For example, authentication may be performed by entering a user name and a password via the operation panel 9. In the description of this embodiment, this mode will be primarily used as an example. For example, the authentication may be biometric authentication performed based on a user's biometric information detected by a detection unit, which is not illustrated, of the image processing device 1. Biometric information includes, for example, a fingerprint or an iris. In addition, for example, the authentication may be card authentication performed based on communication between a card reader, which is not illustrated, of the image processing device 1 and an integrated circuit (IC) card of the user. Card authentication may be static authentication or dynamic authentication. Authentication may be performed based on information read out from a storage medium (for example, a USB memory) connected to a connector, which is not illustrated, of the image processing device 1. For example, the authentication may be performed based on communication between the communication unit 7 of the image processing device 1 and a terminal (for example, mobile terminal) of the user.

Note that among the authentication methods described above, except for authentication via the communication unit 7, the authentication methods are methods in which authentication is performed via the action of user input made to a user interface unit (for example, the operation panel 9, a detection unit for biometric information, a card reader, or a connector) of the image processing device 1. In addition, input of the user name can be omitted in the authentication methods described above, with the exception of password authentication.

The substantive part of the authentication (for example, verification) may be performed by the image processing device 1 itself (authentication management unit). However, the image processing device 1 may transmit authentication information to a server, which is not illustrated, via the communication unit 7, allow the server to perform verification, and use the results to grant authorization to the user. In other words, the image processing device 1 (authentication management unit) only needs to grant authorization based on the results of user authentication, and does not need to perform user authentication itself. At least part of the authentication management unit may be created by the CPU 11 executing a program stored in the storage unit 13, or may be regarded as being part of the controller described previously.

The user names and authentication information (for example, passwords or biometric information) are stored in a database of the image processing device 1 (or server) in association with each other in advance, for example, by operations performed by an administrator or individual users of the image processing device 1. When an operation for authentication is performed by a user, the image processing device 1 refers to the database in order to perform authentication.

In the image processing device of the Second Embodiment, the history display region 121b of the sub-screen 121 displays only the history buttons related to image processing completed in the past by a user authorized by the authentication management unit (the user name “xxxx” in FIG. 8). In other words, if the “copy” function button 107 is selected on the main screen 101 after user authentication, the history buttons 134 specifically for the history of “copy” completed by that user in the past are displayed on the sub-screen 121 after transition. With this configuration, the convenience with which the user can find the history buttons that he or she needs can be further improved.

### Third Embodiment

The Third Embodiment relates to fixed display (priority display) of the history buttons 109 on the main screen 101 and the history buttons 134 on the sub-screens 121. Fixed display is, for example, when multiple history buttons 109 (or 134) are displayed, a particular history button 109 (or 134) is disposed and displayed at an uppermost position.

In more detail, in the third embodiment, when a particular history button 109 is set to be fixedly displayed on the main screen 101, that particular history button 109 (illustrated on the sub-screen 121 as history button 134) is also fixedly displayed on the sub-screen 121. In addition, in the third embodiment, when a particular history button 134 is set to be fixedly displayed on the sub-screen 121, that particular history button 134 (illustrated on the main screen 101 as the history button 109) is also fixedly displayed on the main screen 101.

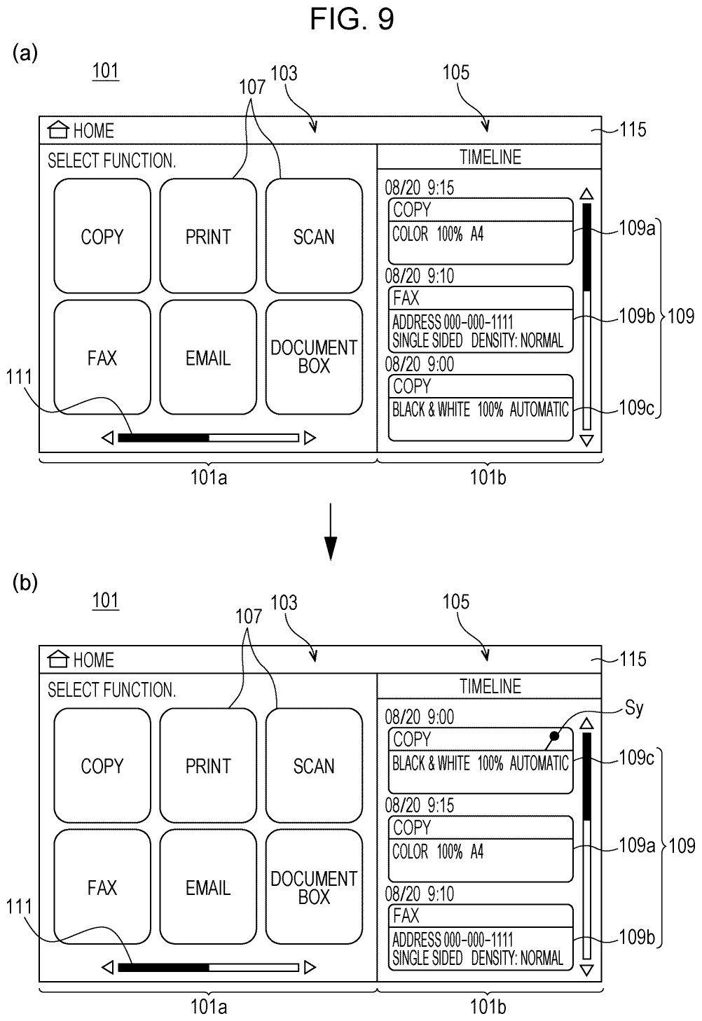

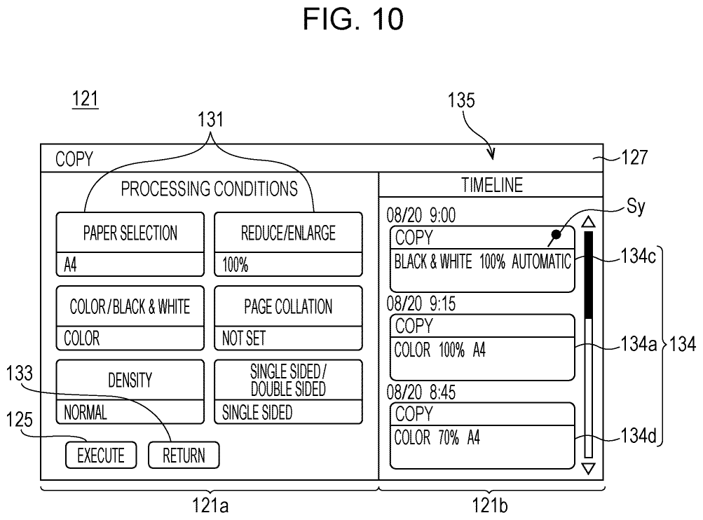

In part (a) of FIG. 9, multiple history buttons 109a, 109b, and 109c are displayed on the main screen 101. For example, if the image processing settings for the history button 109c, among these multiple history buttons 109, are frequently used, the history button 109c can be set to be fixedly displayed. In part (b) of FIG. 9, the history button 109c, which is set to be fixedly displayed, is disposed at the uppermost position. If the “copy” function button 107 is selected on the main screen 101 illustrated in part (b) of FIG. 9, the history buttons 134 are displayed specifically for “copy” on the sub-screen 121 illustrated in FIG. 10. In addition, the history button 109c (illustrated on the sub-screen 121 as a history button 134c), which is set to be fixedly displayed on the main screen 101, is fixedly displayed on the sub-screen 121. The fixed display settings made on the main screen 101 are also reflected on the sub-screen 121, and thus user convenience is improved.

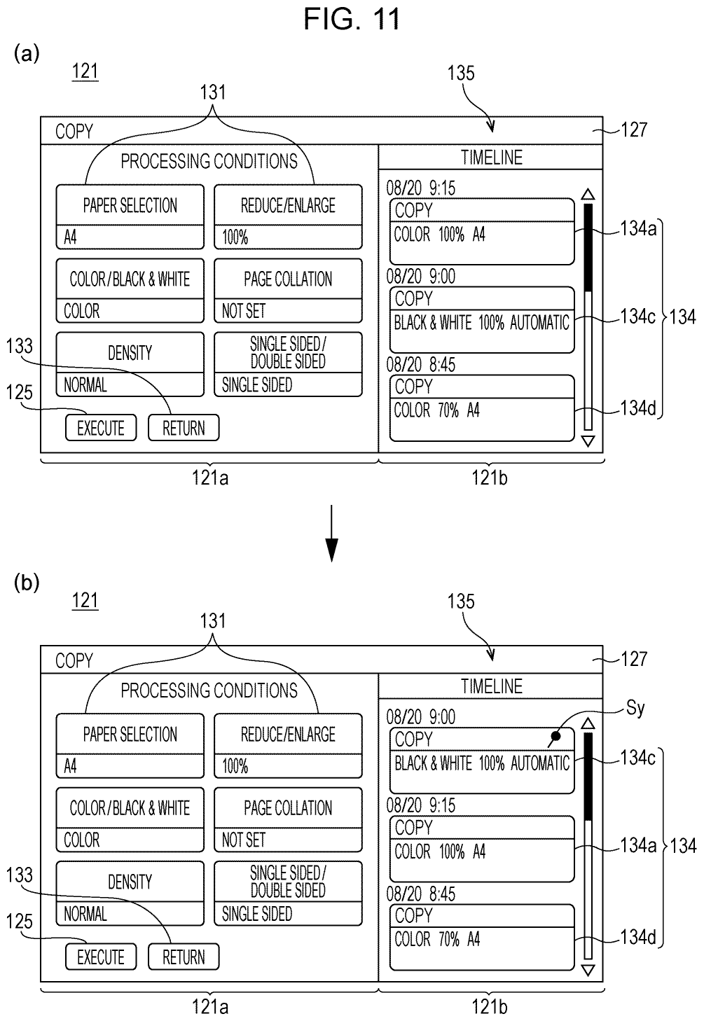

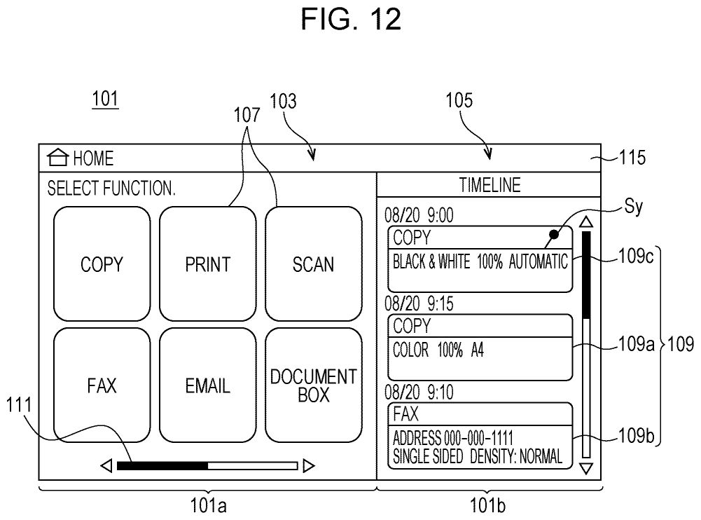

In part (a) of FIG. 11, multiple history buttons 134a, 134c, and 134d are displayed on the sub-screen 121. For example, if the image processing settings for the history button 134c, among these multiple history buttons 134, are frequently used, the history button 134c can be set to be fixedly displayed. In part (b) of FIG. 11, the history button 134c, which is set to be fixedly displayed, is disposed at the uppermost position. If the “return” button 133 is pressed on the sub-screen 121 illustrated in part (b) of FIG. 11, the sub-screen 121 transitions to the main screen 101 illustrated in FIG. 12. The history button 134c (illustrated on the main screen 101 as the history button 109c), which is set to be fixedly displayed on the sub-screen 121, is fixedly displayed on the main screen 101. The fixed display settings made on the sub-screen 121 are also reflected on the main screen 101, and thus user convenience is improved.

Thus, when a particular history button is set to be fixedly displayed on either the main screen 101 or the sub-screen 121, the corresponding history button is automatically fixedly displayed on the other screen. The fixed display is maintained until the setting of the fixed display is cancelled on either the main screen 101 or the sub-screen 121 (which may be a screen on which the fixed display is set, or may be a screen on which the fixed display is automatically set), for example. In other words, the fixed display is maintained even after repeated transitions between the main screen 101 and the sub-screen 121. If the fixed display setting is cancelled on either screen, the fixed display is also automatically cancelled on the other screen.

After the history button 109 or 134 has been set to be fixedly displayed on the main screen 101 or the sub-screen 121, if the screen transitions to a sub-screen 121 corresponding to image processing (e.g., fax) different from the image processing corresponding to those history buttons (e.g., copy), the history button 134 (copy), which has been set to be fixedly displayed, does not need to be displayed on that sub-screen 121 (fax). Refer to FIG. 5 for the sub-screen 121 in this case.

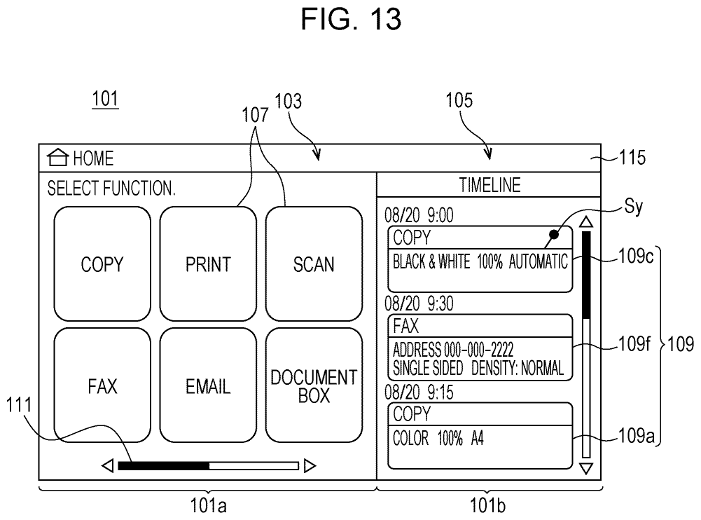

After that, upon returning to the main screen 101 from the sub-screen 121 (fax), the history button 109 (copy), which was set to be fixedly displayed, may be fixedly displayed again. An example of the main screen 101 at this time is illustrated in FIG. 13. The main screen 101 in FIG. 13 includes an additional history button 109f, which corresponds to image processing newly performed on the sub-screen 121 (fax), with respect to the main screen 101 in FIG. 12. However, in the main screen 101 in FIG. 13 as well, similarly to as in the main screen 101 in FIG. 12, the history button 109c is fixedly displayed. When the “copy” function button 107 is selected on this main screen 101, the history button 134c is fixedly displayed in substantially the same way as in the operation already described (see FIG. 10).

The fixed display may be settable for only one history button 109 (134) or may be settable for any number of history buttons. In the latter case, the maximum number of history buttons to be fixedly displayed may be less than or equal to the number of history buttons that can be displayed in the history display region 101b or 121b, for example, or may be less than this number. The types of images corresponding to multiple history buttons set to be fixedly displayed may be different from each other.

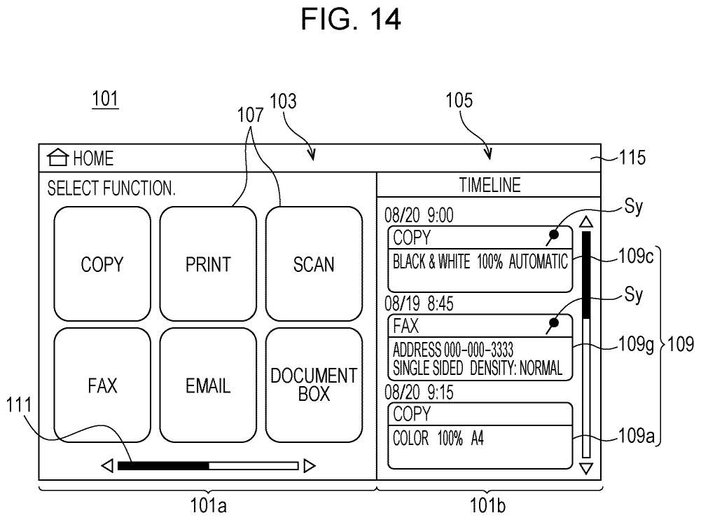

For example, FIG. 14 illustrates an example of the screen displayed when the main screen 101 illustrated in FIG. 12 transitions to the sub-screen 121 (“fax”) illustrated in FIG. 5, fixed display is set for a specific history button 134 in this sub-screen 121 (“fax”), and then the main screen 101 is returned to. On the main screen 101 in FIG. 14, a history button 109g, which has been newly set to be fixedly displayed, is displayed after the history button 109c, which was previously set to be fixedly displayed. In FIG. 14, a case is assumed in which image processing corresponding to the history button 109f illustrated in FIG. 13 was not performed on the sub-screen 121 in FIG. 5.

The fixed display may be realized in various modes, not just in the mode where a button is displayed at the uppermost position among multiple history buttons. In a more generic conceptualization, for example, fixed display can refer to a mode in which a particular history button 109 or 134 is displayed at a fixed position in the history display region 101b of the main screen 101 or the history display region 121b of the sub-screen 121 (note, not the history region 105 or 135), or a mode in which the history button 109 or 134 is displayed such that the user can recognize the position as being fixed. Typically, when multiple history buttons are displayed in a single row in the history display region, a specific history button is displayed at the first or last position in the row.

The “fixed position” mentioned above may be the same for the history display regions 101b and 121b, for example. In this case, the “fixed position” does not necessarily need to strictly be a fixed position, and may be a position that is “recognizable by the user” as being fixed. For example, if, as in the typical example above, the first or last of the multiple display positions at which the multiple history buttons are arranged are fixed display positions in both history display regions 101b and 121b, there is no practical problem even if there is some misalignment between the history display regions 101b and 121b or if there is a difference in the number of history buttons that can be displayed between the history display regions 101b and 121b. Unlike in the description here, the “fixed position” may be different for the history display regions 101b and 121b. The “fixed position” does not need to be the first or last position, for example, and can be a center position.

As mentioned in the description of the First Embodiment, the direction of the row the multiple history buttons may be any direction and is not limited to the vertical direction. In a mode in which two or more history buttons can be fixedly displayed, “the first or last” above may be replaced by “the display positions of two or more consecutive history buttons including the first or last history button”. The order of the two or more fixedly displayed history buttons may be set as appropriate, for example, in the order in which fixed display is set, in chronological order (from oldest or newest), in an order set by the user, or in accordance with the type of image processing.

The operations for setting and canceling the fixed display may be any appropriate operations. For example, as mentioned in Section 1.3.2, fixed display may be set (or may be canceled if fixed display has already been set) by performing a different operation on the history button (e.g., a long tap or a double tap) than the operation performed when the history information corresponding to the history button is to be utilized (e.g., a tap).

If the history button 109 or 134 is fixedly displayed, information indicating that the history button is fixedly displayed may be displayed on the history button. In the examples illustrated thus far, the fact that a history button is fixedly displayed is indicated by a symbol image Sy, which resembles a pin, being displayed within the history button. In addition, the existence of fixed display may be indicated by, for example, making the color of the frame and/or interior of the history button or the shape of the frame different between a history button that is fixedly displayed and the other history buttons.

The above description is only an example of operations related to fixed display, and other operations may be performed in addition to or instead of the above. For example, fixed display may be cancelled in response to a different condition (e.g., a new user logging in) than an operation that directly instructing cancellation of the fixed display. For example, unlike in this embodiment, setting and canceling of fixed display may be separately performed for the main screen 101 and the sub-screen 121, or setting of fixed display may be commonly performed for the main screen 101 and the sub-screen 121 while canceling of fixed display may be performed separately.

### Fourth Embodiment

In a fourth embodiment, in a case where a function button 107 selected on the main screen 101 relates to “fax” or “email” (i.e., communication), when a “communication destination” (also referred to as “address” or “access information”) is entered on the sub-screen 121, the history display region 121b displays only the history buttons 134 related to the entered “communication destination” (i.e., the history buttons specific to that particular communication destination).

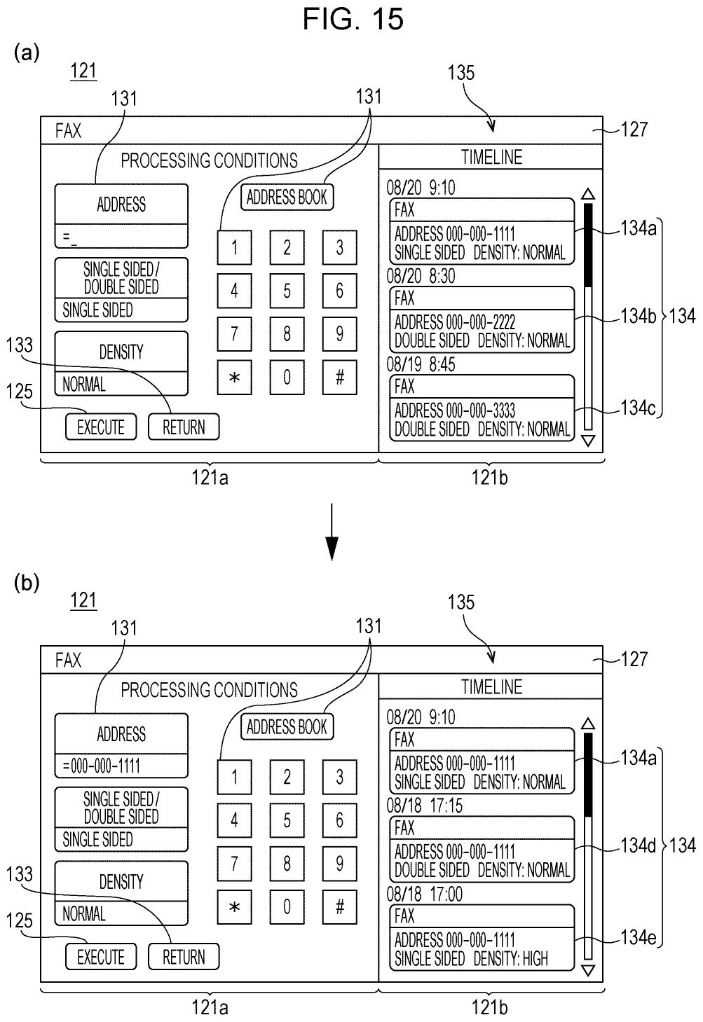

Part (a) of FIG. 15 illustrates the sub-screen 121 for when “fax” is selected on the main screen 101. The sub-screen 121 displays a history button 134a with an address of “000-000-1111”, a history button 134b with an address of “000-000-2222”, and a history button 134c with an address of “000-000-3333”.

Part (b) of FIG. 15 illustrates the sub-screen 121 with “000-000-1111” entered in the “address” field. By entering “000-000-1111” into the “address” field, only the history buttons 134a, 134d, and 134e with the address of “000-000-1111” are displayed in the history display region 121b. By displaying only the history buttons 134 for the entered “address”, the history buttons 134 are reduced in number and user convenience is improved.

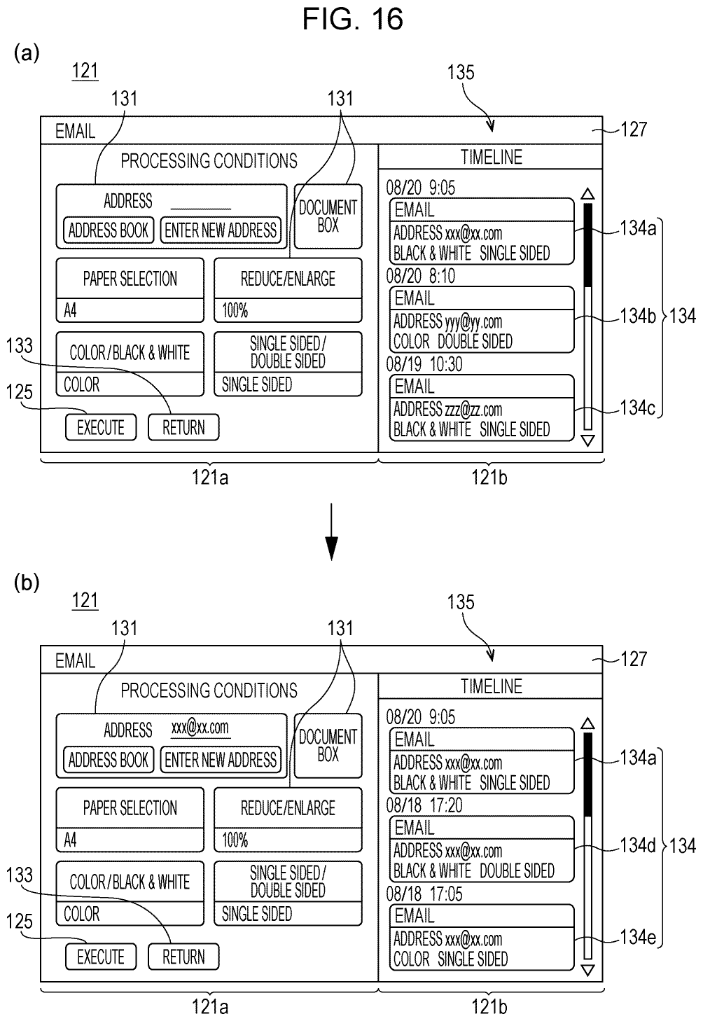

Part (a) of FIG. 16 illustrates the sub-screen 121 for when “email” is selected on the main screen 101. The sub-screen 121 displays the history button 134a with an address of “xxx@xx.com”, the history button 134b with an address of “yyy@yy.com”, and a history button 134c with an address of “zzz@zz.com”.

Part (b) of FIG. 16 illustrates the sub-screen 121 with “xxx@xx.com” entered in the “address” field. When “xxx@xx.com” is entered in the “address” field, only the history buttons 134a, 134d, and 134e with the address of “xxx@xx.com” are displayed in the history display region 121b. By displaying only the history buttons 134 for the entered “address”, the history buttons 134 are reduced in number and user convenience is improved.

1. An image processing device comprising:
an operation panel configured to be capable of displaying a main screen and a sub-screen, the main screen including a menu region in which multiple function buttons corresponding to types of image processing are arranged and the sub-screen configured to be transitioned to from the main screen after one of the function buttons is selected and including a reception region configured to accept an instruction for image processing related to the selected function button,
wherein in the sub-screen, a first history display region is displayed alongside the reception region, the first history display region configured to display multiple history buttons including information on image processing completed previously specifically for image processing corresponding to the selected function button.

2. The image processing device according to claim 1,
wherein in the main screen, a second history display region is displayed alongside the menu region, the second history display region configured to display multiple history buttons including information on image processing completed previously specifically for multiple types of image processing corresponding to the function buttons in the menu region.

3. The image processing device according to claim 1, further comprising:
an authentication management unit configured to grant each user authorization for image processing based on results of user authentication,
wherein only the history buttons related to image processing previously completed by a user granted authorization by the authentication management unit are displayed in the first history display region.

4. The image processing device according to claim 2,
wherein, among the history buttons, a history button selected through an operation performed by the user can be set to be fixedly displayed, and
when, among the history buttons, a specific history button is set to be fixedly displayed on one screen from among the main screen and the sub-screen, a corresponding history button is automatically fixedly displayed on another screen from among the main screen and the sub-screen.

5. The image processing device according to claim 4,
wherein when one of the function buttons is selected and a first sub-screen is transitioned to, the first sub-screen being one of a plurality of the sub-screens, if image processing corresponding to the first sub-screen is different from image processing corresponding to a history button, among the history buttons, set to be fixedly displayed, the history button set to be fixedly displayed is not displayed on the first sub-screen.

6. The image processing device according to claim 5,
wherein when the main screen is returned to from the first sub-screen, the history button set to be fixedly displayed is again fixedly displayed on the main screen.

7. The image processing device according to claim 6,
wherein when the main screen is returned to after a specific history button, among the history buttons, is set to be fixedly displayed on the first sub-screen, both a history button, among the history buttons, set to be fixedly displayed before transition to the first sub-screen and the history button set to be fixedly displayed on the first sub-screen are fixedly displayed on the main screen.

8. The image processing device according to claim 4,
wherein the multiple history buttons are displayed in a row, and a history button, among the history buttons, that is set to be fixedly displayed is disposed at a beginning or an end of the row.

9. The image processing device according to claim 4,
wherein when the history button is fixedly displayed, information indicating that the history button is fixedly displayed is displayed in the history button.

10. The image processing device according to claim 1,
wherein when the sub-screen is related to communication, when access information for accessing a specific communication partner is entered in the sub-screen, only history buttons, among the history buttons, that are specifically for the specific communication partner are displayed in the first history display region.

11. The image processing device according to claim 1, wherein information on image processing displayed on the history buttons includes text or a symbol image related to at least one selected from a group consisting of type of image processing, processing conditions, date and time of processing, user name, and communication destination.

12. The image processing device according to claim 11,
wherein the processing conditions include at least one from among image quality and page layout.

13. The image processing device according to claim 1,
wherein the types of image processing include at least copying, scanning, and faxing.
